(19) United States
(12) Patent Application Publication
(10) Pub. No.: US 2021/0312744 A1
(43) Pub. Date: Oct. 7, 2021

(54) NON-DESTRUCTIVE TEST APPARATUS AND METHODS

(71) Applicant: Ocean Bay Information & Systems Management, LLC, Hanahan, SC (US)

(72) Inventor: Karen Bruer, Hanahan, SC (US)

(21) Appl. No.: 17/218,521

(22) Filed: Mar. 31, 2021

Related U.S. Application Data
(60) Provisional application No. 63/003,017, filed on Mar. 31, 2020.

(51) Int. Cl. G07D 7/15; G01N 25/18; G07D 7/17

(52) U.S. Cl. CPC G07D 7/15; G07D 7/17; G01N 25/18

(57) ABSTRACT

The present disclosure relates to portable devices for detecting substandard or counterfeit materials on-site at ports of entry or other locations where the materials are situated, preferably before acceptance or entry of such materials into the supply chain. In particular, the devices and methods relate to use of a handheld probe capable of applying a temperature change to the surface of a suspect material at a contact area, sensing the material's temperature response at one or more surface locations distinct from the contact area, and comparing the temperature response data to a reference standard, which corresponds to temperature response of a standard or noncounterfeit sample.

### CROSS REFERENCE TO RELATED APPLICATION

This application claims priority to U.S. Provisional Application No. 63/003,017, filed on Mar. 31, 2020, which is herein incorporated by reference in its entirety.

### STATEMENT OF GOVERNMENT SUPPORT

This invention was made under Cooperative Research and Development Agreement No. CR-16-002 between Ocean Bay Information and Systems Management, LLC and Savannah River Nuclear Solutions, LLC, operated for the United States Department of Energy under Prime Contract No. DE-AC09-085R22470 by Savannah River Nuclear Solutions, LLC. The Government has certain rights in the invention.

### FIELD

The present disclosure relates to portable non-destructive devices and methods for detecting substandard or counterfeit materials on-site at ports of entry or other locations where the materials are situated, preferably before acceptance or entry of such materials into the supply chain.

### BACKGROUND

Counterfeit, deficient or non-conforming material entering the supply chain has become an epidemic in recent years. This substandard material affects thousands of components made from all materials, including, but not limited to, rubber, plastics, composites, and metals. Of specific concern is raw material which is used to fabricate critical components for repair or replacement parts in existing systems. Also of concern is processed or raw material provided for original manufacture of critical parts of sophisticated or complex structures and equipment, such as airplanes and other transportation or military defense machinery, safety and medical equipment, chemical and nuclear reactors, and any other situations where it is required that substandard or counterfeit materials are detected prior to being accepted and used.

Certain devices and methods are known for examining and determining the makeup of materials suspected of being substandard. For example, microcalorimetry is a known technique that requires an adiabatic environmentally controlled chamber for placement of the suspect material, which severely limits the size of the material that can be tested and typically requires acceptance of delivery and then transport to a laboratory environment having the necessary adiabatic chamber. X-ray techniques also are known, but have the concomitant disadvantage of x-ray danger, need for special training and inability to differentiate between the same materials that have been processed by different techniques. When the raw material is, for example, a metal, it is often important to conduct a nondestructive test capable of identifying and thus rejecting materials that have not been properly processed, such as properly hardened, annealed, or tempered.

What is needed are new inspection devices capable of on-site nondestructive (NDT) detection of counterfeit, deficient and non-nonconforming materials. The needed devices and methods should provide a gate keeping, first line of defense function to protect unwary contractors, manufacturers, and protect critical supply chains.

### SUMMARY

In accordance with the purposes of the disclosed devices and methods, as embodied and broadly described herein, the disclosed subject matter relates to portable NDT devices and methods of making and use thereof. In a preferred embodiment, the device is battery powered, transportable, rugged and capable of use by a single individual, in the form of a handheld probe that can be placed into contact with suspect material and provide prompt pass or fail feedback to the individual user. The material can then be rejected as noncompliant or counterfeit, and/or may be subject to additional testing, as desired for the specific situation or material. As such, the devices and methods of the present disclosure provide a convenient on-site gate keeping function to protect unwary contractors and manufacturers and protect critical supply chains.

The present disclosure provides, inter alia, a portable or handheld apparatus for convenient on-site detection of counterfeit or substandard material, the apparatus including a probe having a face surface configured for juxtaposition or contact with a surface of the material; a temperature varying source configured to heat or chill at least a portion of the material; one or more sensors located at different locations than the temperature varying source and configured to sense a thermometric response transmitted through at least a portion of the material; a data collection system configured to collect one or more thermometric response signals from the of sensors; a database of predetermined thermometric response data corresponding to thermometric response in non-counterfeit or standard material; a processor configured to compare data from the data collection system to data in the database of predetermined thermometric response data; and

an indicator configured to signal whether the data from the data collection system matches the data in the database of predetermined thermometric response data, wherein a mis-match indicates that the material is potentially counterfeit or substandard material.

In an embodiment, the temperature varying source is a thermoelectric cooler (TEC), which may be located in a central portion of the probe face surface. In one case, the collected heat response signals comprise one or more of temperature per time, temperature amplitude, time to peak amplitude, and peak angle. In a preferred embodiment, the one or more sensors are thermistors configured to detect a thermometric response as low as 0.001 to 0.0000001 degree Centigrade at the surface of the material. In one aspect, two or more sensors are configured to detect thermometric response at a different angle or distance to the temperature varying source.

In one case, the probe face surface is in the form of a circle having a planar, curved, convex, or concave shape configured to match the shape of the sample. In another case, at least some of the sensors are located on the probe face surface with each sensor positioned at an equal radial distance away from the temperature varying source. In another case, the sensors are located at two or more radial distances away from the temperature varying source to form concentric circles of sensors around the temperature varying source on the probe face surface.

In one embodiment, a ridge or wall structure extends from the probe face surface and is capable of reducing ambient temperature or wind influence during temperature varying source input and sensing.

In one embodiment, a spring, magnet or weight is configured to apply consistent pressure between the probe and the surface of the material during temperature varying source input and sensing.

In one case, the probe detects a suspect material selected from the group consisting of metal or rubber. In one embodiment, the material is aluminum. In another aspect, the apparatus is capable of differentiating two different samples of the same metal that have been processed in different ways. In another case, the different ways of processing are selected from the group consisting of one or more different tempering, annealing, quenching, hardening, and heat treating methods.

In one embodiment, the apparatus includes a probe housing wherein the data collection system, processor, and a power source are in or on the probe housing. In another, at least a portion of the data collection system, one or more power sources, and the processor are located in a separate housing in electrical communication with the probe.

In a preferred embodiment, the temperature varying source is capable of producing a heat pulse of a predetermined duration and each of a plurality of sensors is capable of detecting the material's response to the heat pulse.

The present disclosure further provides methods for detection of counterfeit or substandard material, by contacting a surface of the material with a temperature varying source to heat or chill at least a portion of the material; sensing the material's thermometric response at one or more locations different than the contacting; collecting one or more thermometric response signals from the sensors; comparing data from the thermometric response signals to a database of predetermined thermometric data corresponding to non-counterfeit or standard material; and determining whether the data from the data collection system matches the data in the database of predetermined thermometric data, wherein a data mismatch indicates a substandard or counterfeit material. The method may also include applying consistent pressure between the temperature varying source and the material and/or reducing ambient temperature or wind influence during contacting and sensing.

In preferred embodiments, the temperature varying source applies an impulse of heat or chilling effect for a duration in the range of five to 15 sec. via direct contact with the material being tested. In one aspect, a plurality of sensors are configured to detect thermometric response at a different angle or distance to the temperature varying source, wherein at least some of the sensors are positioned in the range of from 0.25 to 1.0 inch from the temperature varying source. In another aspect, two or more of a plurality of thermistors sensors are configured to detect thermometric response at a different angle or distance to a TEC, wherein the thermistors are positioned in the range of from 0.25 to 0.5 inches from the each other.

Additional advantages of the disclosed apparatus and methods will be set forth in part in the description which follows, and in part will be obvious from the description. The advantages of the disclosed apparatus and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### DESCRIPTION OF THE FIGURES

The accompanying figures, which are incorporated in and constitute a part of this specification, illustrate several aspects of the disclosure, and together with the description, serve to explain the principles of the disclosure.

FIG. 1 depicts a side view of a probe according to one embodiment of the present disclosure.

FIG. 2 depicts a view of the bottom surface face of a probe according to one embodiment of the present disclosure.

FIG. 3 depicts a view of the bottom surface face of a probe having a spring-loaded temperature varying source according to one embodiment of the present disclosure.

FIG. 4 depicts a side view of the probe of FIG. 3.

FIGS. 5 A and B depict thermometric data collected using a probe according to the present disclosure when testing (in a blind study) different samples of aluminum processed to differing tempers before testing.

FIGS. 6 A and B depict thermometric data collected using a probe according to the present disclosure when testing 5086-H32 and 5086-H116 Aluminum, which is the same alloy but with different processing characteristics.

FIG. 7 shows thermometric data repeatability test on 5086 H-32 and 5086 H-116 aluminum for runs taken at three angles, averaged to achieve a single curve for each set.

FIG. 8 shows thermometric data collected using a probe according to the present disclosure when testing two samples each of aluminum, copper, carbon steel, and stainless steel in rod form.

FIG. 9 shows thermometric data collected using a probe according to the present disclosure when testing two samples each of aluminum, copper, carbon steel, and stainless steel in plate form.

FIG. 10 A shows thermometric data collected using a probe according to the present disclosure.

FIG. 10 B shows thermometric data collected using a probe according to the present disclosure.

FIG. 11 A illustrate the angle difference on the trailing slope of the thermometric response curve for a sample of aluminum.

FIG. 11 B illustrates the angle difference on the trailing slope of the thermometric response curve for a sample of aluminum.

### DETAILED DESCRIPTION

The devices and methods described herein may be understood more readily by reference to the following detailed description of specific aspects of the disclosed subject matter and the Examples included herein.

Before the present devices and methods are disclosed and described, it is to be understood that the aspects described below are not limited to specific methods or specific components and materials, as such may, of course, vary. It is also to be understood that the terminology used herein is for purposes of describing particular aspects or embodiments and is not intended to be limiting.

The present disclosure provides portable or handheld devices for convenient on-site detection of counterfeit or substandard material by using a probe or wand capable of being operated by an individual person, typically with only a limited or minimal amount of training. In a preferred embodiment, the handheld probe is made of plastic or other suitably lightweight but robust material and has a probe face surface configured for juxtaposition or contact with a surface of the material. Thus, the face is brought, typically by hand, into juxtaposition with a surface of the suspect material so that the components located on the face of the probe contact the surface of the material.

In general, the necessary components located on the probe face and brought into contact with the material are a heat or cold source, such as a thermoelectric cooler, capable of transmitting heat or cold into portion of the material at the area of contact between the temperature varying source and the surface of the material being tested, and a plurality of sensors located at different locations than the temperature varying source and configured to sense a thermometric response transmitted through at least a portion of the material.

The devices and methods of the disclosure also generally include a data collection system configured to collect one or more thermometric response signals from the plurality of sensors, a database of predetermined thermometric (e.g., heat transmission) data corresponding to thermometric (e.g., heat) response in non-counterfeit or standard material, and a computer processor to compare data from the data collection system to data in the database of predetermined thermometric response data. Conveniently, the preferred devices also include an indicator configured to signal whether the data from the data collection system matches the data in the database of predetermined thermometric response data. A data mis-match thus alerts the user that the material is potentially counterfeit or substandard material.

The materials tested may include raw or fabricated materials including, but not limited to, rubber, plastics, composites, and metals. Of specific concern is raw material and particularly metals. The material may be any shape, such as plates, pipes, bars, ingots, rolls or other raw material shapes and particularly may be any aluminum, steel, or titanium. A particular advantage of the preferred devices and methods disclosed herein are that the same materials, such as aluminum 1075, may be differentiated (and substandard material rejected at the port of entry, etc.) based on processing methods, such as hardening or annealing processes, that were applied (or were not applied) to the materials before testing.

By “temperature varying source” herein we mean any component or components, devices or methods capable of heating and/or chilling at least a portion of a material, such as by indirect or direct contact with a surface of the material, thus causing a temperature change in at least a portion of the material. The temperature change need not be of any specific amplitude or duration and can be selected, and vary by probe design (e.g., distance between temperature varying source and sensors, sensitivity of sensors, and material being tested, by a person of ordinary skill in the art given the teachings herein. In each case, the temperature varying source can be selected to provide a sufficient temperature change upon contact for a suitable duration by varying the voltage provided to the source. Voltages are typically in the range of about 1 to 6, about 1 to 5, or about 1 to 3 volts, but may be any suitable voltage as may be selected by a person of ordinary skill based on the material and the teachings herein such that a sufficient temperature variation is applied by the source so that the sensor(s) can detect a response at distance away from the source, as discussed herein.

By “thermometric” herein we mean temperature data collected at the surface of a material being tested. Such data may be collected directly as temperature or may be initially in the form of ohms detected by sensors such as thermistors, which sense temperature variation as electrical resistance over time. By “thermometric response” herein we mean the delta between a first temperature and a second temperature (or first and second resistance or ohms) that is different than the first as a response to a heating or chilling pulse applied to the material, typically at a different location than the location of the pulse. Thermometric responses in certain aspects of the disclosure include temperature variations over time and which are transmitted and/or dissipate through a portion of the material, for example, specific temperature, peak or amplitude temperature, and peak angle, for example, slope of the trailing edge of the temperature peak over time. Again, where sensors detect temperature variation as changes in resistance, the thermometric response data may be collected as ohms or other indicators of resistance due to temperature change over time, such as seconds, or over one or more cycles, i.e., the period of time between pulses.

The present disclosure also provides methods for on-site detection of counterfeit or substandard material by contacting a surface of the material with a handheld probe having, for example, a heat source, to transmit a heat pulse into at least a portion of the material. In a preferred embodiment that handheld probe includes a plurality of sensors capable of sensing the material's response to the heat pulse. The methods thus include sensing the material's response to the heat pulse (or other temperature varying source) by sensing heat (or other thermometric data) transmitted through at least a portion of the material at one or more locations different than the contacting step and collecting one or more thermometric response signals from the sensors. The thermometric response data is then compared to predetermined thermometric response data, such as a reference standard database, corresponding to the thermometric response of non-counterfeit or standard material. As a result, the user can determine whether the data from the data collection system sufficiently matches the data in the database of predetermined thermometric response data. A thermometric response mismatch indicates a substandard or counterfeit material. In general, the methods indicate detection of a counterfeit or substandard material when a data mismatch of 1% to 20% occurs, when 1% to 10% occurs, or from 5% to 10% occurs, between the collected thermometric response data and the reference standard database.

By “on-site” herein, we mean that the handheld probe is capable of being used in the field, such as at the port of entry or potential delivery for acceptance of suspect material, without having to transport the material to a laboratory or other environment such as an adiabatic chamber. In preferred embodiments, the probe head has features for minimizing errors due to potential ambient temperature changes or wind effects, such as a circular ridge structure around a circular probe face wherein any temperature varying sources and sensors or located and thus environmentally protected within the circle defined by the ridge.

It is preferred that the probe face surface provides a location for both the temperature varying source(s) and the plurality of sensors and that the face surface substantially mirrors the shape of the suspect material. When the material has a flat planar surface, the probe face preferably has a flat planar surface to facilitate contacting the source(s) and sensors against the material surface and applying consistent contact for the duration of the test, which may take a few seconds to less than two minutes, preferably less than or about 1 minute. The probe face surface is preferably a round disk and may be flat or contoured in a convex or concave manner to match the surface of the material. Similarly, where the material is a rod or cylinder, the probe face will preferably have a curved shape to match. In one aspect, the test is completed in a time duration in the range of about 10 to 120 seconds, about 30 to 100 seconds, or preferably about 60 seconds or less (including a heat or chilling pulse of typically ten seconds), or other durations which are convenient for handheld probe application by a single individual user with consistent contact and pressure.

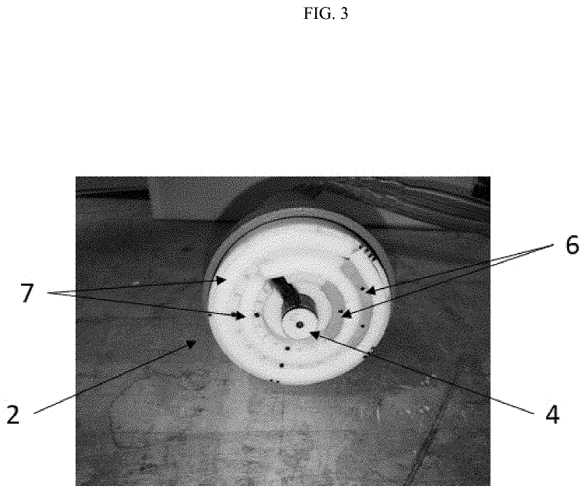

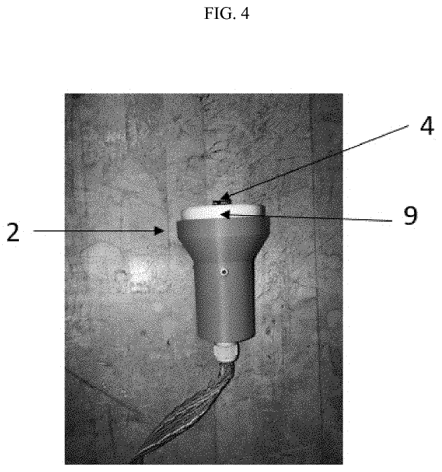

To assist in applying a consistent contact and pressure, we have found that a spring-loaded component is advantageous. For example, as shown in FIGS. 3 and 4 the probe face has located on its surface a temperature varying source in the center, which is in the form of a spring-loaded thermoelectric cooler (TEC) 4 protruding from the surface 3 of the probe. The TEC has a spring such that when sufficient pressure is applied by the user bringing the handheld probe into contact with the surface of the material, the spring compresses and triggers a heat impulse into the material when the predetermined pressure is achieved and preferably maintained for the duration of the test. At this pressure, the spring is compressed such that the sensors also are in contact with the surface of the material at an appropriate and consistent pressure. Any suitable static pressure may be utilized and preferably is consistently applied throughout the duration of the test in the range of about 0.25 to 10 pounds, in the range of about 0.3 to 8 pounds, or in the range of about 1 to 3 pounds. In one embodiment, the preferred pressure is approximately 2 lbs of static pressure. As discussed herein, a weight or spring and a pressure sensor may be utilized to ensure that consistent contact pressure is applied during testing. Consistent probe pressures also are preferably utilized between the data gathered for reference purposes and the ultimate on-site field testing.

The temperature varying sources suitable for use herein are not limited to TECs. Any device or method capable of varying the temperature of the surface of the material being tested can be used so long as the method or device is capable of applying a repeatable temperature shift in the material for a repeatable duration and of sufficient intensity to be detected at a location on the material at a distance from the source. Such alternative temperature varying devices and methods include, but are not limited to, lasers, miniature heating pads, heating coils, and heat guns. Preferably such devices and methods are those capable of being applied by an individual user on site and/or can be located on the face of a handheld probe or wand structure and, preferably, may powered by a portable battery.

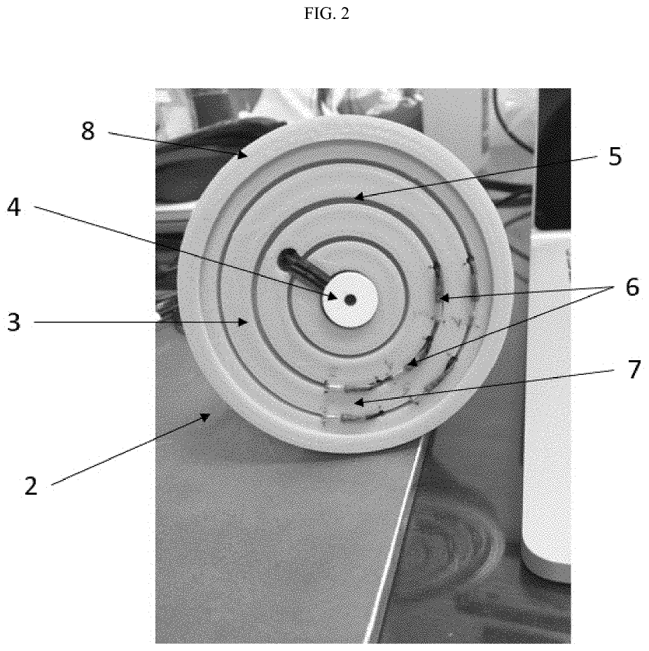

One or more sensors may be used to detect thermometric response at locations on the surface of the material that are different than the contact area between the surface and the temperature varying source. Preferably, a plurality of sensors is used and may be mounted on the probe face surface at different locations. In other preferred embodiments, pairs of sensors or arrays of multiple sensors are utilized each at a different location, preferably at a different distance and/or angle with respect to the temperature varying source or sources. In one aspect, the sensors comprise a pair of sensors located along a straight line extending radially away from the temperature varying source. In another aspect, as illustrated in FIG. 2 below, the sensors are arranged in a circular array around the temperature varying source. In this way, each sensor is at a different angle to the source(s) like the numbers on the face of a clock. In another aspect, each sensor of the array of sensors also is at different radial distances with respect to a centrally located temperature varying source. In such an embodiment, the sensors can be arranged as concentric circles at two or more radial distances or can be arranged as a spiral around the temperature varying source with each sensor or sensor pair being separated from the source by a different radial distance.

The sensitivity of the NDT devices and methods are related to the type of sensor and the number and location of the sensors. Thermistors are a class of temperature sensing devices that are capable of detecting very small fluctuations in temperature over time.

Thermistors are solid state temperature sensing devices which can act like an electrical resistor but are temperature sensitive. Thermistors can be used to produce an analogue output voltage with variations in temperature and as such can be referred to as a transducer. This is because it creates a change in its electrical properties due to an external and physical change in heat. Thermistors are typically two-terminal solid state thermally sensitive transducers constructed using sensitive semiconductor based metal oxides with metallized or sintered connecting leads formed into a ceramic disc or bead. This allows the thermistor to change its resistive value in proportion to small changes in temperature.

Thermistors are available in a range of types, materials and sizes characterized by their response time and operating temperature. Also, hermetically sealed thermistors eliminate errors in resistance readings due to moisture penetration while still offering high operating temperatures and a compact size. The three most common types are: Bead thermistors, Disk thermistors, and Glass encapsulated thermistors. Thermistors typically can operate in one of two ways, either by increasing or decreasing their resistive value with changes in temperature. There are two types of thermistors: negative temperature coefficient (NTC) of resistance and positive temperature coefficient (PTC) of resistance. Negative temperature coefficient of resistance thermistors, or NTC thermistors reduce or decrease their resistive value as the operating temperature around them increases. NTC temperature thermistors have a negative electrical resistance versus temperature (R/T) relationship. The relatively large negative response of an NTC thermistor means that even small changes in temperature can cause significant changes in their electrical resistance.

Another important characteristic of a thermistor is its “B” value. The B value is a material constant which is determined by the material from which it is made. It describes the gradient of the resistive (R/T) curve over a particular temperature range between two temperature points. Each thermistor material will have a different material constant and therefore a different resistance versus temperature curve. Then the B value will define the thermistor's resistive value at a first temperature or base point, (which is usually 25 C), called T1, and the thermistor's resistive value at a second temperature point, for example 100 C, called T2. The B value defines the thermistor's material constant between the range of T1 and T2. By knowing the B value of a particular thermistor (such as obtained from manufacturer's datasheet), a person skilled in the art can readily produce a table of temperature versus resistance to construct a suitable graph using the following normalized equation:

$$Thermistor Equation$$

$${B}_{( {T}_{1} / {T}_{2} )} = \frac{{T}_{2} \times {T}_{1}}{{T}_{2} - {T}_{1}} \times ln ( \frac{{R}_{1}}{{R}_{2}} )$$

Where:

T1 is the first temperature point in Kelvin;

T2 is the second temperature point in Kelvin;

R1 is the thermistor's resistance at temperature T1 in Ohms; and

R2 is the thermistor's resistance at temperature T2 in Ohms.

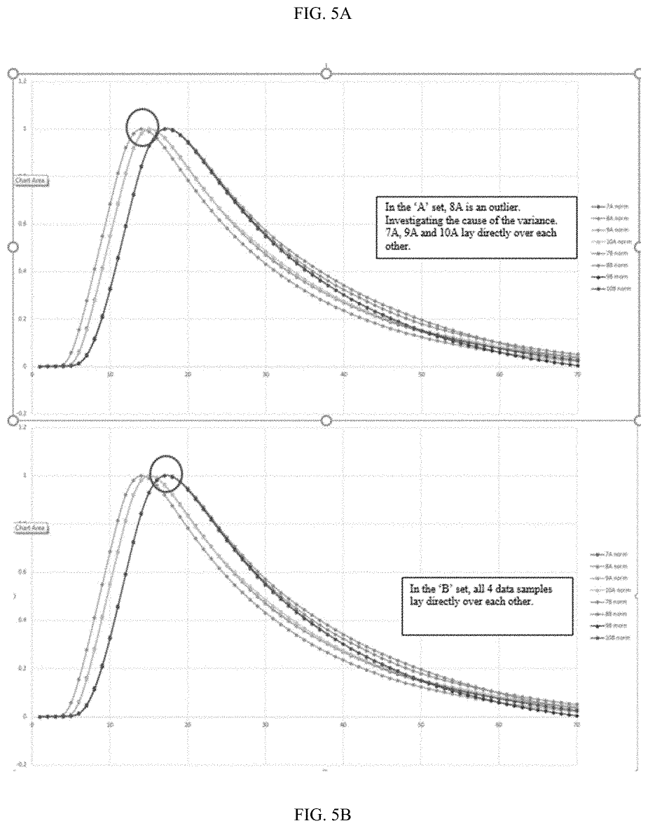

While any suitable sensor that can detect thermometric response data can be used in aspects of the present disclosure, the currently preferred sensors are thermistors that are capable of signaling a thermometric response as small as 0.0001 to 0.00000001 degree C. at the surface of the material being tested, preferably in the range of from 0.00001 to 0.0000001 degree, and more preferably in the range of from 0.000001 to 0.000000001 degree. In certain aspects, the sensors detect and signal the occurrence over time of any temperature variation of a small fraction of one degree C., such as 0.0000001 degree C. Illustrative thermistors, and as used in the Examples below, are available from Mouser Electronics, Mansfield Tex., such as Measurement Specialties number GC2315R-3-200. Temperature variation signals are then transmitted to the data collection system as data points in terms of discrete temperature data points per time or can be represented graphically, for computer processing and analysis. See, Tables and FIGS. 5-11, herein below. In FIGS. 5-11 graphically showing thermometric data, unless otherwise specified the vertical axis shows ohms measured as resistance by thermistors, and the horizontal axis shows cycles.

The preferred distance between sensors and distance between sensor and temperature varying source depends on the speed of processing desired and the desired sensitivity of the apparatus or method in terms of accuracy is discriminating between standard and substandard materials. In one aspect, the distance between a sensor and the temperature varying source is in the range of from one-eighth to 2.0 inches, more preferably in the range of from one-quarter to 1.5 inches, and most preferably in the range of from one-quarter to 1.0 inches. In certain embodiments the distance between sensors and between a sensor and the source was one-quarter inch, which provides a useful combination of nanosecond processing speed and sensitivity of detection. In another aspect, the distance between each sensor of a plurality of sensors is in the range of from one-eighth to 2.0 inches, more preferably in the range of from one-quarter to 1.5 inches, and most preferably in the range of from one-quarter to 1.0 inches. In another aspect, the distance from the temperature varying source to the outermost sensor is in the range of from one-quarter to 3 inches, more preferably in the range of from one-quarter to 2.5 inches, and most preferably in the range of from one-quarter to two inches.

In one embodiment a plurality of sensors and a temperature varying source are positioned on the face surface of a handheld probe in which the surface face of the probe has a size in the range of from 4 square inches to about 25 square inches, or in the range of from 5 square inches to about 20 square inches, or in the range of from 9 square inches to about 16 square inches. Preferably, the probe is small enough to be conveniently handheld, carried and consistently applied, but large enough to position a temperature varying source and enough sensors at different locations, angles and distances for the desired sensitivity of detection. In one embodiment, 6 or more thermistors are included and placed at different angles with respect to a TEC on the central face of a circular disk-shaped probe head, as shown in FIG. 3.

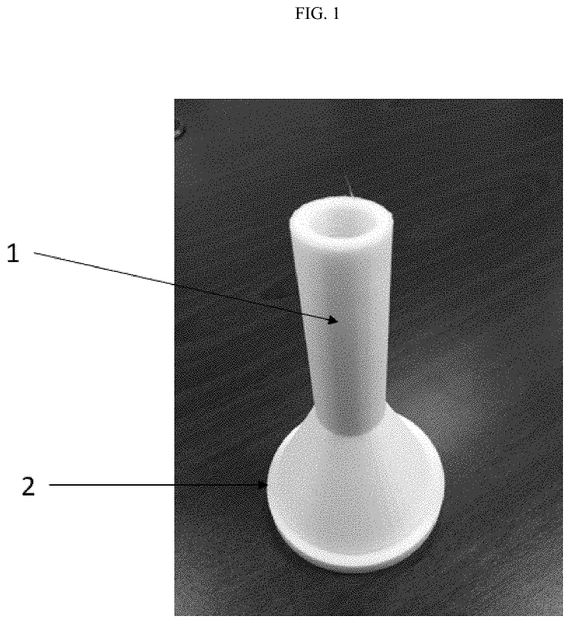

Referring now to FIG. 1 through FIG. 4, FIG. 1 shows an illustrative handheld probe or wand having a relatively small diameter holding surface 1, extending between the individual user and the probe head 2. Probe head 2 has a face surface 3 on which are mounted several structures or components which we have found particularly useful in carrying out the objects of the present disclosure. More specifically, probe face surface 3 is shaped as a circular disk having a centrally located temperature varying source 4, in this case a TEC configured to send a pulse of heat into the material being tested. Located circumferentially around the source 4 are grooves 5 for placement of a plurality of sensors 6, in this case three pairs of thermistors.

Between the grooves 5 and the source 4 are positioned a ring of foam or other insulating material 7. Circumferentially located around the above-referenced source and sensing components is ridge structure 8 positioned adjacent to the peripheral edge of the face surface 3 to minimize wind and ambient temperature fluctuations during testing.

As shown in FIGS. 3 and 4, the probe face surface 3 also includes a spring activated temperature varying source 4 for applying consistent pressure between the active components on the probe face and the surface of the material being tested. Spring activated source 4 protrudes from the probe face 3 further than the sensors 6. As the spring is compressed by user-applied pressure on the probe toward the material, the source is brought into line with the sensors and a temperature varying pulse is triggered when the sensors contact the surface of the material and the predetermined pressure is applied. Alternatives for applying consistent pressure during testing include any suitable devices such as, but not limited to, a weight, clamp, or magnet, for applying consistent pressure, although a spring is currently preferred.

The probe also contains communication equipment, such as a hardwire system or wi-fi transmission capability to transmit signals from the sensors to the data collection system and optionally between the probe head and a control panel. Preferably the method includes a user interface control panel capable of turning the apparatus on and off, selecting reference data bases, and signaling a pass-fail indication to the user. The control panel can be located on an associated laptop or computer, on the probe head or other device, such as a container for housing a battery and any ancillary equipment or database collection or processing, or communications between components, controllers, and databases.

In one embodiment, a plurality of sensors is positioned at different angles such that the data per distance and time can then be averaged to provide a single data point for thermometric data for a given distance and time from a single temperature varying source. By collecting thermometric data in terms of temperature per time at very small increments of time and temperature change, such as the above referenced fractions of a degree C. and nanoseconds, or as ohms and cycles as described above and depicted in the FIGS, precise data points can be derived showing not only temperature per time, but also temperature amplitude, time to peak amplitude, and peak angle. We have surprisingly found that peak angle can be used as a highly sensitive indicator of a mismatch between tested and reference materials. Peak angle includes the slope of the temperature per time peak and, more importantly, the angle or slope on the trailing edge of the peak after additional time elapses after a heat or chilling pulse. Use of the trailing edge data can detect a significant mismatch even where the remainder of the temperature over time curves can appear relatively matched. This is illustrated, for example, in FIGS. 5-11.

The devices and method disclosed herein include as a component (or via access to) a computerized data base of thermometric response data of, for example, processed raw material for use as a known standard for comparative analyses. This pairing of equipment and electronic reference database provides NDT devices and methods for field testing compositions and processing attributes of both metallic and non-metallic materials, whereby the thermometric response data of the known standard is compared to the incoming on-site collected thermometric response data. Preferably, a control panel or other device is optionally provided which allows an individual user to select an appropriate reference database prior to or after contacting the suspect material, and then select a different database when testing a different type of suspect material.

A computer associated with the device, such as a laptop carried over the shoulder of the operator and in wi-fi or other communication with the control panel and/or probe head is configured to promptly compare the in the field-collected thermometric data and the selected reference database, so as to provide a clear pass-fail signal to the user, indicating a match or mismatch to the reference standard. In this manner, very significant quantities of materials can be tested by a single individual without accepting delivery, importation, or otherwise moving the materials, such as to a lab for testing.

The examples below are intended to further illustrate certain aspects of the methods and devices described herein and are not intended to limit the scope of the claims.

### Examples

The following examples are set forth below to illustrate aspects of the devices, methods and results according to the disclosed subject matter. These examples are not intended to be inclusive of all aspects of the subject matter disclosed herein, but rather to illustrate representative methods, devices, and results. These examples are not intended to exclude equivalents and variations of the present invention, which are apparent to one skilled in the art.

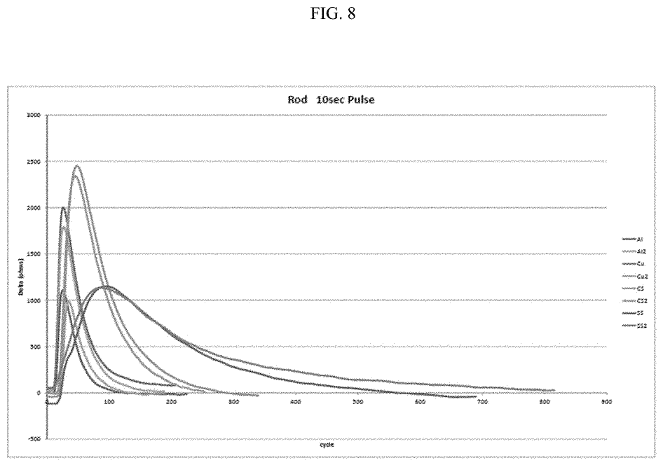

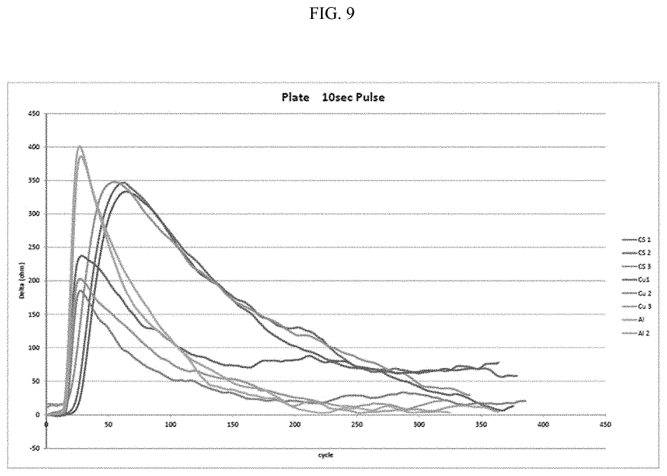

Example 1: We tested a variety of different metals as shown in FIGS. 8 and 9 using a probe and a 10 second pulse through the TEC. Spacing was 1 inch apart (TEC-1″-1st thermistor-1″-2nd thermistor) with two in line thermistors. The device was held steady in place and pressured by a weight. Data is tabulated below and shown in new FIGS. 8 and 9. Each curve shown represents a material with distinct amplitude, shape, and peak/time characteristics.

TABLE 1

| Date/Time | Heat Source | Therm 1 | Therm2 | Pulse |
|---|---|---|---|---|
| 12/5/2016 13:38 | 34454.5699 | 35094.23 | 35054.98 | 0 |
| 12/5/2016 13:38 | 34450.6747 | 35093.73 | 35054.27 | 0 |
| 12/5/2016 13:38 | 34446.0433 | 35093.3 | 35053.56 | 0 |
| 12/5/2016 13:38 | 34443.316 | 35092.83 | 35052.76 | 0 |
| 12/5/2016 13:38 | 34442.5422 | 35092.33 | 35051.97 | 0 |
| 12/5/2016 13:38 | 34443.272 | 35091.82 | 35051.23 | 0 |
| 12/5/2016 13:38 | 34444.6673 | 35091.44 | 35050.68 | 0 |
| 12/5/2016 13:38 | 34446.0398 | 35091.19 | 35050.32 | 0 |
| 12/5/2016 13:38 | 34447.5719 | 35090.97 | 35050.03 | 0 |
| 12/5/2016 13:38 | 34448.3989 | 35090.85 | 35049.87 | 0 |
| 12/5/2016 13:38 | 34449.2149 | 35090.73 | 35050.13 | 0 |
| 12/5/2016 13:38 | 34450.9797 | 35090.63 | 35050.77 | 0 |
| 12/5/2016 13:38 | 34452.5223 | 35090.62 | 35051.75 | 10 |
| 12/5/2016 13:38 | 34453.287 | 35090.48 | 35052.88 | 0 |
| 12/5/2016 13:38 | 34451.8443 | 35088.76 | 35053.86 | 0 |
| 12/5/2016 13:38 | 34448.2453 | 35083.67 | 35054.78 | 0 |
| 12/5/2016 13:38 | 34444.0533 | 35076.4 | 35055.4 | 0 |
| 12/5/2016 13:38 | 34441.3202 | 35068.74 | 35055.43 | 0 |
| 12/5/2016 13:38 | 34438.2468 | 35061.85 | 35054.73 | 0 |
| 12/5/2016 13:38 | 34436.184 | 35056.15 | 35053.17 | 0 |
| 12/5/2016 13:38 | 34433.8961 | 35051.11 | 35051.4 | 0 |
| 12/5/2016 13:38 | 34428.4759 | 35047.1.8 | 35048.64 | 0 |
| 12/5/2016 13:38 | 34423.2281 | 35043.29 | 35045.7 | 0 |
| 12/5/2016 13:38 | 34422.0472 | 35040.36 | 35043.23 | 0 |
| 12/5/2016 13:38 | 34420.5363 | 35038.06 | 35041.12 | 0 |
| 12/5/2016 13:38 | 34417.4 | 35036.12 | 35038.99 | 0 |
| 12/5/2016 13:38 | 34414.77 | 35034.54 | 35036.78 | 0 |
| 12/5/2016 13:38 | 34499.145 | 35032.97 | 35034.67 | 0 |
| 12/5/2016 13:38 | 34406.8202 | 35031.52 | 35032.48 | 0 |
| 12/5/2016 13:38 | 34403.7818 | 35030.19 | 35029.97 | 0 |
| 12/5/2016 13:38 | 34402.9525 | 35028.73 | 35027.03 | 0 |

Example 2: Tests were set up utilizing five 3″×3″×1″ samples of aluminum in a blind study. Four of the samples were processed to differing tempers while one was held as the control. Each of the samples were followed by individual character marking.

The specimens were placed into contact with a probe utilizing two ¾″×¼″ thermistors distanced 1 inch apart. A third ¾″×¼″ thermistor was present in the area, non-contact off material to record ambient temperature.

The controllable factors during this series were the pulse duration, volts applied, thermoelectric cooler size, distance placement for A differential measurement, contact pressure, specimen size and shape.

We used a 1 inch spacing between the thermoelectric cooler (TEC) and each thermistor (plate and e rod material shapes). Two thermistors were utilized placed in a straight line from the TEC and each one inch apart. During the first set of data collection the slopes and achieved amplitude peak in time overlaid very closely, as shown in FIG. 5. When comparing the data with initial tests, the amplitude peak in time was very close; however, the slope of the resulting curves was not the same. We have found that the shape of the curve changes as the distance between the thermistors changes. Earlier experiments did not have the thermistors spaced using a calibrated measurement for achieving the 1 inch spacing, accounting for the variation in slope shape.

We also found that increasing the electric potential difference from 1 Volt to 3 Volts, keeping the pulse time to 10 seconds, decreased the variability and data capture time. In the data plots shown in FIGS. 5A and B, the original/unprocessed sample (data set ‘A’) had a distinctly faster time to amplitude peak than was exhibited in the processed sample (data set ‘B’). The plots displayed are of 7 through 10 minute intervals, displayed as cycles and ohms measured at the thermistors. All data sets were normalized to eliminate the initial noise.

Example 3: Two sets of data were collected using a modified probe configuration, similar to the probe of Example 2 except a spacing change between the TEC and the first of the two in-line thermistors. For this experiment the data sets were held constant utilizing the ¼″ distance between thermistors and ½″ distance between first thermistor and thermoelectric cooler (TEC). Eight data sets were run (10 each) on 5086-H32 and 5086-H116 Aluminum, which is the same alloy but with different processing characteristics. Both materials were tested with differing directional orientation of the probe, i.e., H=horizontal and V=vertical.

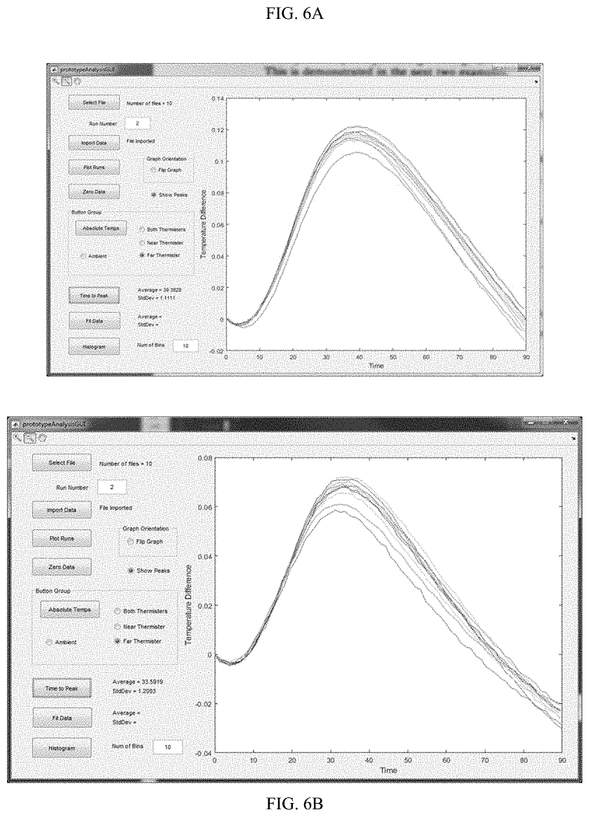

With regard to FIGS. 6 A and B, measuring the time to peak of the signals showed definitive differences between the two differently processed samples of the same material. The data from the tests (Tables below) also show a clear distinction between the two processed specimens.

TABLE 2

| | | Ave All Cycles | | Cycle 1 | | Cycle 2 | | I Cycle 3 | |
|---|---|---|---|---|---|---|---|---|---|
| Data | | Time to | | Time to | | Time to | | Time to | |
| Set | Direct | Peak | Std Dev | Peak | Std Dev | Peak | Std Dev | Peak | Std Dev |
| | | H-32 | | | | | | | |
| 3-1 | H | 41.8387 | 2.4575 | 46.4954 | 0.9366 | 39.3826 | 1.1111 | 39.638 | 1.0918 |
| 3-2 | V | 34.9936 | 1.6414 | 36.3127 | 1.5952 | 33.5919 | 1.2093 | 35.0822 | 0.6021 |
| 4-1 | H | 40.7447 | 3.3238 | 45.0971 | 1.6606 | 38.1039 | 1.073 | 39.033 | 0.6217 |
| 4-2 | V | 34.1857 | 3.2283 | 36.2248 | 1-5895 | 32.7213 | 1.7473 | 33.7809 | 2.1114 |
| | | H-l16 | | | | | | | |
| 5-1 | H | 31.9618 | 2.543 | 32.2562 | 2.7134 | 32.2171 | 2.9517 | 31.4418 | 1.7323 |
| 5-2 | V | 21.0291 | 1.8676 | 20.0417 | 1.6704 | 22.5616 | 1.6134 | 20.484 | 1.204 |
| 6-1 | H | 25.6802 | 2 2881 | 25.6981 | 2.9192 | 24.8713 | 1.9293 | 26.473 | 1.5837 |
| 6-2 | V | 24.0542 | 15.5678 | 23.7258 | 11.7258 | 19.9578 | 2.0797 | 28.4791 | 23.3388 |
| | | H-32 | | | | | | | |
| 3-1 | H | 41.8387 | 2.4575 | 46.4954 | 0.9366 | 39.3326 | 1.1111 | 39.638 | 1.0918 |
| 4-1 | H | 40.7447 | 3.3238 | 453571 | 1.6606 | 33.1039 | 1.073 | 39.033 | 0.6217 |
| | | H-116 | | | | | | | |
| 5-1 | H | 31.9618 | 2.S43 | 32.2562 | 2.7134 | 32.2171 | 2.9517 | 31.4418 | 1.7323 |
| 6-1 | H | 25.6802 | 2.2831 | 25.6981 | 2.9192 | 24.8713 | 1.9293 | 26.473 | 1.5837 |

| | | Ave All Cycles | | Cycle 1 | | Cycle 2 | | Cycle 3 | |
|---|---|---|---|---|---|---|---|---|---|
| Data | | Time to | | Time to | | Time to | | Time to | |
| Set | Direct | Peak | Std Dev | Peak | Std Dev | Peak | Std Dev | Peak | Std Dev |
| | | H-32 | | | | | | | |
| 3-2 | V | 34.9936 | 1.6414 | 36.3127 | 1.S952 | 33.5919 | 1.2093 | 35.0822 | 0.6021 |
| 4-2 | V | 34.1857 | 3.2283 | 36.2248 | 1.5895 | 32.7213 | 1.7473 | 33.7809 | 2.1114 |
| | | H-116 | | | | | | | |
| 5-2 | V | 21.0291 | 1.8676 | 20.0417 | 1.6704 | 22.5616 | 1.6134 | 20.484 | 1.204 |
| 6-2 | V | 24.0542 | 15.5678 | 23.7258 | 11.7258 | 19.9578 | 2.0797 | 28.4791 | 23.3388 |

Example 4: In addition to aluminum, testing and data collection was conducted on Viton Rubber using the same probe as in Example 3. For rubber testing, the probe parameters were held constant utilizing the ¾″ distance between thermistors and ½″ distance between first thermistor and thermoelectric cooler (TEC) (TEC CH-21-1.0-1.3 from TE Technology). These data sets were comprised of 5 complete cycles on Viton Rubber 55 durometer, 70 durometer and 90 durometer. The data (Table below) was significant in that the time to peak curves broke differently for each specimen, as shown in ohms.

TABLE 3
Viton Rubber

| Durometer | 55 | 70 | 90 |
|---|---|---|---|
| Run 1 | 19.0086 | 17.1696 | 15.2346 |
| Std Dev | 7.7056 | 1.4506 | 1.2959 |
| Run 2 | 15.4297 | 16.1058 | 11.4808 |
| Std Dev | 0.5396 | 0.5232 | 5.368 |
| Run 3 | 16.512 | 17.674 | 15.244 |
| Std Dev | 1.2918 | 1.3449 | 2.0006 |

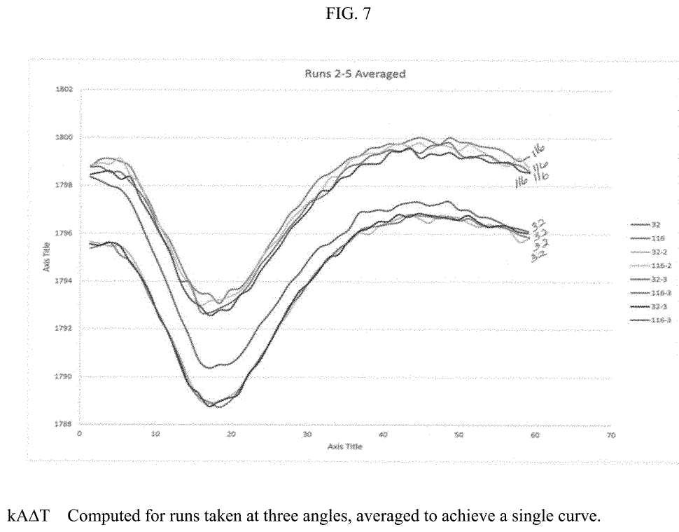

Example 5: Additionally, two pieces of matching material (5086 aluminum H-32 and H-116) in composition, size and shape were subject to repeatability test runs. With the averaging of differentially positioned thermistors the time to peak became less obvious, however the amplitude of the signals became more distinct, as shown in FIG. 7. The probe configuration of this Example was the same as for Example 3.

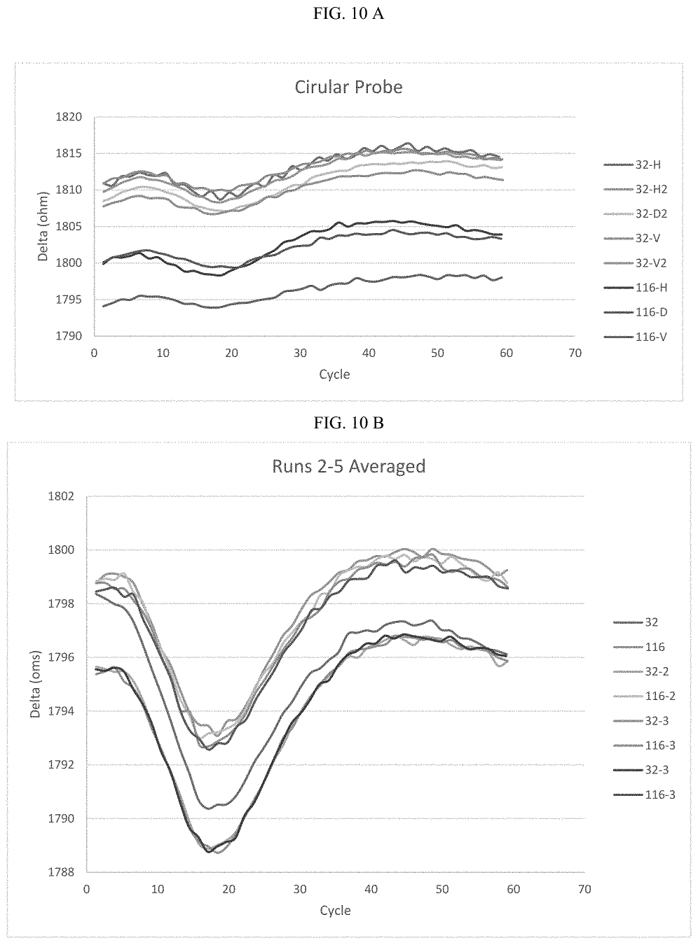

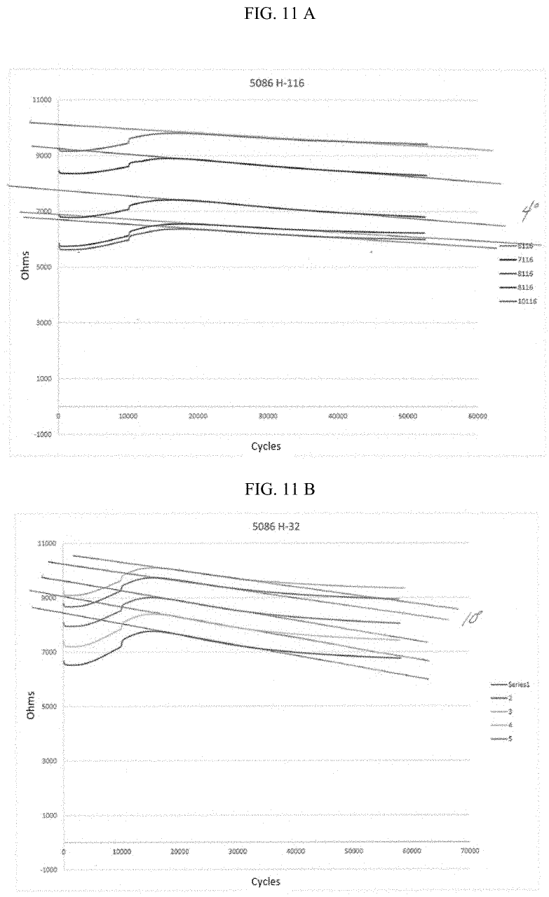

Example 6: The materials of Example 5 were then tested using the probe configuration as shown in FIGS. 1 and 2. The TEC was size ½″ and the spacing between the TEC and the first set of thermistors was ¾″; and the spacing between the first and second sets of thermistors also was ¼″. Thermometric data from these tests is shown in FIGS. 10 and 11, clearly showing a significant mismatch between the two different materials, via handheld tests conducted in the field using embodiments of the probes and methods according to the present disclosure.

The compositions, devices, and methods of the appended claims are not limited in scope by the specific devices and methods described herein, which are intended as illustrations of a few aspects of the claims and any devices and methods that are functionally equivalent are within the scope of this disclosure. Various modifications of the compositions, devices, and methods in addition to those shown and described herein are intended to fall within the scope of the appended claims. For example, the temperature varying source can apply a pulse of cold to the material to be tested. In this case, a TEC can also be used by rotating it 180 degrees to chill rather than heat the material. Various solid materials may be tested using the devices and methods disclosed herein, including, but not limited to, aluminum, copper, composites, graphite, Kevlar, plastics, titanium, and carbon, stainless and other steels. Further, while only certain representative compositions, devices, and methods, and aspects of these compositions, devices, and methods are specifically described, other compositions, devices, and methods and combinations of various features of the compositions, devices, and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. A portable or handheld apparatus for convenient on-site detection of counterfeit or substandard material, the apparatus comprising:
a probe having a face surface configured for juxtaposition or contact with a surface of the material;
a temperature varying source configured to heat or chill at least a portion of the material;
a plurality of sensors located at different locations than the temperature varying source and configured to sense a thermometric response transmitted through at least a portion of the material;
a data collection system configured to collect one or more thermometric response signals from the plurality of sensors;
a database of predetermined thermometric response data corresponding to thermometric response in non-counterfeit or standard material;
a processor configured to compare data from the data collection system to data in the database of predetermined thermometric response data; and
an indicator configured to signal whether the data from the data collection system matches the data in the database of predetermined thermometric response data, wherein a mis-match indicates that the material is potentially counterfeit or substandard material.

2. An apparatus according to claim 1 wherein the temperature varying source comprises a thermoelectric cooler (TEC).

3. An apparatus according to claim 1 wherein the temperature varying source is located in a central portion of the probe face surface.

4. An apparatus according to claim 1 wherein the collected heat response signals comprise one or more of temperature per time, temperature amplitude, time to peak amplitude, and peak angle.

5. An apparatus according to claim 1 wherein one or more of the plurality sensors comprise thermistors.

6. An apparatus according to claim 1 wherein one or more of the plurality of sensors are configured to detect a thermometric response as low as 0.001 to 0.0000001 degree Centigrade at the surface of the material.

7. An apparatus according to claim 1 wherein two or more of the plurality of sensors are configured to detect thermometric response at a different angle or distance to the temperature varying source.

8. An apparatus according to claim 1 wherein the probe face surface is in the form of a circle having a planar, curved, convex, or concave shape configured to match the shape of the sample.

9. An apparatus according to claim 1 wherein at least some of the plurality of sensors are located on the probe face surface with each sensor positioned at an equal radial distance away from the temperature varying source.

10. An apparatus according to claim 9 wherein the plurality of sensors are located at two or more radial distances away from the temperature varying source to form concentric circles of sensors around the temperature varying source on the probe face surface.

11. An apparatus according to claim 1 wherein ridge or wall structure extending from the probe face surface is capable of reducing ambient temperature or wind influence during temperature varying source input and sensing.

12. An apparatus according to claim 1 further comprising a spring, magnet or weight configured to apply consistent pressure between the probe and the surface of the material during temperature varying source input and sensing.

13. An apparatus according to claim 1 wherein the plurality of sensors and the temperature varying source are positioned on the face surface of the probe in an area in the range of from 10 square cm to about 250 square cm.

14. An apparatus according to claim 1 wherein the material is selected from the group consisting of metal or rubber.

15. An apparatus according to claim 1 wherein the material is aluminum.

16. An apparatus according to claim 1 further comprising a probe housing wherein the data collection system, processor, and a power source are in or on the probe housing.

17. An apparatus according to claim 1 wherein at least a portion of the data collection system, one or more power sources, and the processor are located in a separate housing in electrical communication with the probe.

18. An apparatus according to claim 1 wherein the temperature varying source is capable of producing a heat pulse of a predetermined duration.

19. An apparatus according to claim 1 wherein each of the plurality of sensors is capable of detecting the material's response to a heat pulse.

20. An apparatus according to claim 1 wherein the apparatus is capable of differentiating two different samples of the same metal that have been processed in different ways.

21. An apparatus according to claim 20 wherein the different ways of processing are selected from the group consisting of one or more different tempering, annealing, quenching, hardening, and heat treating methods.

22. An apparatus according to claim 1 further comprising one or more multimeters configured to capture data from the plurality of sensors.

23. A method for detection of counterfeit or substandard material, the method comprising:
contacting a surface of the material with a temperature varying source to heat or chill at least a portion of the material;
sensing the material's thermometric response at one or more locations different than the contacting;
collecting one or more thermometric response signals from the sensors;
comparing data from the thermometric response signals to a database of predetermined thermometric data corresponding to non-counterfeit or standard material; and
determining whether the data from the data collection system matches the data in the database of predetermined thermometric data, wherein a data mismatch indicates a substandard or counterfeit material.

24. A method according to claim 23 wherein the temperature varying source comprises a thermoelectric cooler (TEC).

25. A method according to claim 23 further comprising applying consistent pressure between the temperature varying source and the material.

26. A method according to claim 23 wherein the collected thermometric response signals comprise one or more of temperature per time, temperature amplitude, time to peak amplitude, and peak angle.

27. A method according to claim 23 wherein the sensing is conducted using one or more thermistors.

28. A method according to claim 23 wherein the plurality of sensors are configured to detect thermometric response at a different angle or distance to the temperature varying source.

29. A method according to claim 23 wherein the sensing detects heat response at an equal radial distance away from the temperature varying source.

30. A method according to claim 23 wherein the sensing detects heat response at two or more radial distances away from the temperature varying source using concentric circles of sensors around the temperature varying source.

31. A method according to claim 23 wherein at least two or more concentric circular arrays of sensors are located radially with respect to a temperature varying source position on a handheld probe.

32. A method according to claim 23 wherein each of a plurality of sensors are located at two or more radial distances away from the temperature varying source position on a handheld probe at one or more different angles to the temperature varying source.

33. A method according to claim 23 further comprising reducing ambient temperature or wind influence during contacting and sensing.

34. A method according to claim 23 further comprising compressing a spring to apply consistent pressure to the surface of the material during contact with the temperature varying source and sensing.

35. A method according to claim 31 wherein the surface of the probe face is in a form that matches the surface of the material.

36. A method according to claim 23 wherein the material is elected from the group consisting of metal and rubber.

37. A method according to claim 23 wherein the material is aluminum.

38. A method according to claim 23 wherein the temperature varying source applies an impulse of heat or chilling effect for a duration in the range of five to 15 sec.

39. A method according to claim 23 wherein the temperature varying source applies an impulse of heat or chilling effect via direct contact with the material being tested.

40. An apparatus according to claim 1 wherein two or more of the plurality of sensors are configured to detect thermometric response at a different angle or distance to the temperature varying source, wherein at least some of the sensors are positioned in the range of from 0.25 to 1.0 inch from the temperature varying source.

41. An apparatus according to claim 1 wherein two or more of the plurality of sensors are configured to detect thermometric response at a different angle or distance to the temperature varying source, wherein the sensors are positioned in the range of from 0.25 to 0.5 inches from the each other.
